(19) United States
(12) Patent Application Publication
(10) Pub. No.: US 2013/0161180 A1
(43) Pub. Date: Jun. 27, 2013

(54) Solar Water Still

(71) Applicant: William R. Brown, Watkinsville, GA (US)

(72) Inventor: William R. Brown, Watkinsville, GA (US)

(21) Appl. No.: 13/716,513

(22) Filed: Dec. 17, 2012

Related U.S. Application Data
(60) Provisional application No. 61/580,370, filed on Dec. 27, 2011.

(51) Int. Cl. B01D 1/00

(52) U.S. Cl. CPC B01D 1/0035
USPC 202/176; 202/187

(57) ABSTRACT

Embodiments of a system and method for a solar water still that receives a flow of water from a raw, non-potable water source and removes impurities from the water are disclosed. An exemplary solar water still system receives the raw water, distributes the raw water along an interior surface heated by exposure to the sun such that a portion of the distributed raw water evaporates into a space contained within the system, provides for the water vapor to contact a surface of an inner component cooled by the raw water source, and collects purified condensate resulting from the water vapor having come in contact with the cool surface of the inner component.

### CROSS-REFERENCE TO RELATED APPLICATIONS

This application claims priority under 35 U.S.C. §119(e) to U.S. provisional application entitled “SOLAR WATER STILL,” filed on Dec. 27, 2011 and assigned application Ser. No. 61/580,370, the entire contents of which are hereby incorporated by reference.

### BACKGROUND

The present disclosure concerns distillation columns and, more particularly, embodiments of a water distillation system configured to take advantage of a radiant heat source, such as the sun, to evaporate raw water and collect a purified condensate.

Potable water is not a given in all places and situations around the world. In some third world countries, for example, water purification and distribution infrastructure, that is otherwise commonplace in developed countries, is nonexistent. Even in countries that have the infrastructure for generating and distributing potable water, natural disasters and other situations can interrupt the supply.

Safe drinking water is a necessity regardless of location or situation and, as such, there is a need in the art for a system and method that can be used to generate a supply of drinking water from a water source that is not potable or may not be potable.

### BRIEF SUMMARY

Various embodiments, aspects and features of a solar water still encompass a system and/or a method to receive a flow of water from a non-potable water source. The flow of water is received via an inner tube or inner column component that extends vertically within a space defined by an outer, generally bell-shaped housing. The upper end of the inner tube component flairs outward to the interior surface of the side walls of the outer housing such that two spaces are defined within the interior of the bell-shaped outer housing—a first interior space at the top of the bell accessible by the flow of water from within the inner tube component and a second interior space defined by the exterior of the inner tube component and the interior side walls of the outer housing component.

As the water flow exits the inner tube component to occupy the first interior space (which is above the second interior space), the water is distributed into the second interior space down along the interior walls of the outer housing via a series of slits. As the water sheets down the interior walls of the outer housing, which are heated as a result of the outer housing being exposed to the sun, the water evaporates into the volume of the second interior space. The vapor may then condense on the exterior surface of the inner tube component, which is cooler than the water vapor as a result of having transferred the cold raw water up into the first interior space. The condensate may then be collected as a potable water source as it runs down the exterior wall of the inner tube component. Advantageously, because the water changed from a liquid state to a vapor state and back to a liquid state, impurities that may have existed in the raw water may have been removed from the condensate during the evaporation process.

### BRIEF DESCRIPTION OF THE SEVERAL VIEWS OF THE DRAWING

FIG. 1A is a cutaway perspective view of an exemplary application of a solar water still according to an illustrative embodiment;

FIG. 1B is a cross-sectional view of the illustrative embodiment of a solar water still featured in FIG. 1A;

FIG. 1C is a cross-sectional view of the illustrative embodiment of a solar water still featured in FIG. 1A, depicted with raw water received into the inner column component and upper interior space;

FIG. 2A is the cross-sectional view depicted in FIG. 1B, shown with sectional lines AA and BB;

FIGS. 2B and 2C are top plan views of the FIG. 1 embodiment depicted along the sectional lines AA and BB of FIG. 2A, respectively;

FIG. 3 is a detailed view of the distribution slots of an exemplary embodiment of a solar water still; and

FIG. 4 is an illustration of a geometric relationship of an inner column and outer housing in an exemplary solar water still.

### DETAILED DESCRIPTION

Embodiments and aspects of a solar water still provide a solution to the above-described need in the art, as well as other needs in the art, by providing a potable water supply from an otherwise non-potable water source. An exemplary embodiment intakes a relatively cool flow of non-potable water via an inner column component, distributes the cool flow along the interior surface of a radiantly heated outer housing component such that a water vapor is generated via evaporation from contact with the heated outer housing component, contains the water vapor within a space defined between the outer housing component and inner column component, allows the water vapor to condense on the outer surface of the inner column component that is cooled by virtue of the cool water intake, and collects the condensate to supply it as a potable drinking source. Additional aspects of the invention provide for minimal moving parts, ease of cleaning, versatile mounting structures, modular addition of accessory components such as, but not limited to, pumps, solar power cells, ultraviolet (“UV”) purification modules, chemical dispensaries, etc.

Certain embodiments of a solar water still are configured to be suspended over, or located nearby, a body of water. It is envisioned that a solar water still may be constructed of any material understood by one of ordinary skill in the art to be suitable for a given application including, but not limited to, certain plastics, aluminum, grade 304 or grade 316 stainless steel, etc. Notably, while it is envisioned that some embodiments may include one or more components constructed from a plastic or other material, it will be understood by one of ordinary skill in the art that materials that provide for relatively minimal resistance to heat transfer, i.e. materials that do not exhibit insulating qualities, will be preferred for certain components.

An exemplary embodiment of a solar water still includes a bell-shaped outer housing that is vertically oriented in such a manner as to surround a central water intake column. Notably, although the outer housings of the exemplary embodiments provided in this application are generally described as being “bell-shaped,” other shapes are envisioned that generally provide for the functionality taught in this description. As such, one of ordinary skill in the art will recognize that a solar water still which falls within the scope of this description is not limited to including an outer housing component that necessarily takes the form of a bell. For example, it is envisioned that the outer housing component may essentially be in the form of a cube, a rectangular object, a pyramid, etc. Similarly, the central water intake column may be constant in diameter as it extends upward into the interior space defined by the outer housing until it opens in a flaring configuration such that the outer most edges defined by the flared portion communicate with the interior surface of the outer housing via a series of slits or ports, however, it is envisioned that certain embodiments may not include a central intake column that features a constant diameter or, indeed, even necessarily takes the form of a cylinder. For instance, it is envisioned that the central water intake column may have a cross-section that is cylindrical, oval, square, rectangular, triangular, hexagonal, etc. and, as such, the particular length, diameter, or cross-sectional shape of an interior water intake column will not be a limiting aspect on the scope of a solar water still.

A pumping mechanism in communication with the central water intake column may be used to lift cool, subsurface water into and through the intake column. Notably, as one of ordinary skill in the art will appreciate, the pumping mechanism may be any pumping mechanism, of either centrifugal or positive displacement type, suitable for pumping a volume of water through the intake column including, but not limited to, a submersible pump, a ram pump, a diaphragm pump, a propeller pump, a peristaltic pump, a gear pump, a piston pump, etc. Other embodiments may not include a pump per se, relying instead on differential pressure created by a water source having a water level above the required water level within the solar water still. Moreover, the pumping mechanism may be driven electrically in some embodiments via a solar power cell or other available power source while in other embodiments the pumping mechanism may take advantage of non-electrical power sources for driving the pump such as, but not limited to, a manual crank and gear box, gravitational force, etc. As subsurface water may be cool in temperature relative to ambient above surface temperatures to which components of a water still are exposed (particularly the outer housing component), the supply of cool, subsurface water received into a water still via the intake column may be continuously distributed along one or more relatively warmer surfaces such that a water vapor is generated through evaporation.

That is, as the cool, non-potable water received into the still is distributed and made to descend along the warm, interior surfaces of an outer shell component, for example, a portion of the water may be caused to evaporate and take the form of a water vapor contained within a space defined by the outer shell component. Advantageously, as a portion of the non-potable water evaporates, impurities within the water necessarily remain on the warm interior surface of the outer housing and are discharged from the still as the remaining portion of water that did not evaporate runs down the interior surface of the outer housing and drips into the environment surrounding the still. Notably, because a volume of impurities may have been removed in this way from the water as it changed from a liquid state to a gaseous state, the portion of water in vapor form may be potable. Further, as will be understood by one of ordinary skill in the art, the outer housing component, as well as other components, may have been heated relative to the temperature of the intake water due to prolonged exposure to the sun or by way of an external heating source driven by a local power source.

As described above, the intake water may be of a temperature that is cool relative to the outer components of the solar water still. Accordingly, the central intake column, due to containing the cool intake water, may also be cool relative to the outer components. As such, the water vapor generated from the intake water being distributed along the heated outer components may condense when contacting the outer surface of the cool, central water intake column. The resulting condensate, having been purified by virtue of the change of states from liquid to vapor and back to liquid, may be potable. As the purified condensate aggregates and runs down the outer surface of the central intake column, a collection basin may capture the condensate for delivery to a user. In some embodiments, the condensate may be pumped while in other embodiments it is envisioned that gravity may be leveraged to flow the water through a dispensing feature.

Turning now to the figures, where like labels represent like elements throughout the drawings, various aspects, features and embodiments of a solar water still will be presented in more detail. The examples as set forth in the drawings and detailed description are provided by way of explanation and are not meant as limitations on the scope of a solar water still. A solar water still according to an embodiment of the invention thus includes any modifications and variations of the following examples as come within the scope of the appended claims and their equivalents.

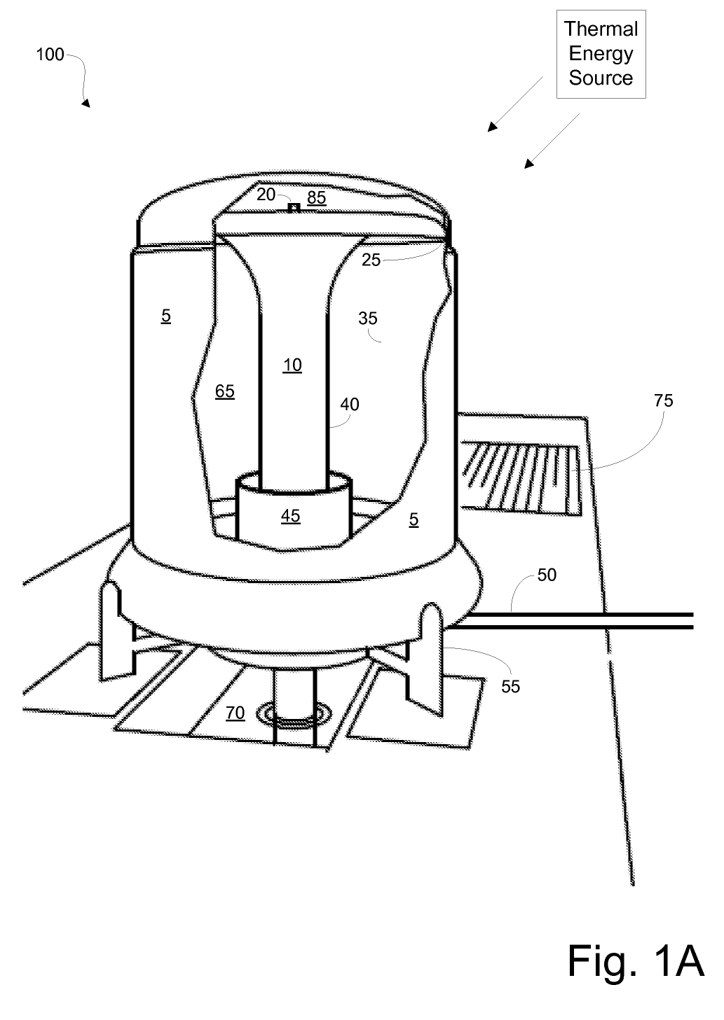

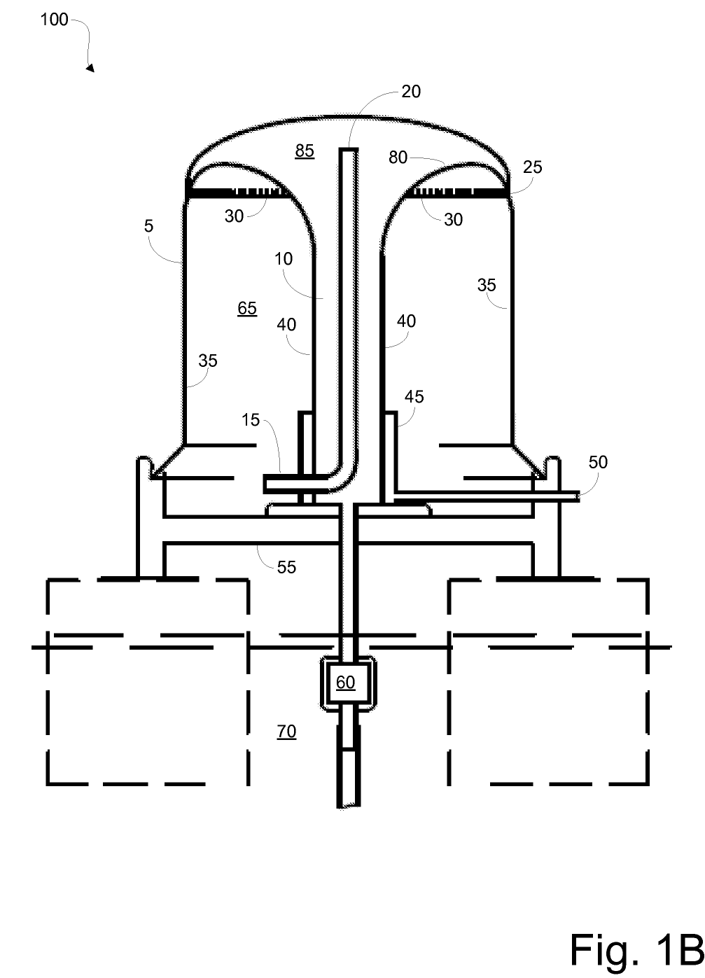

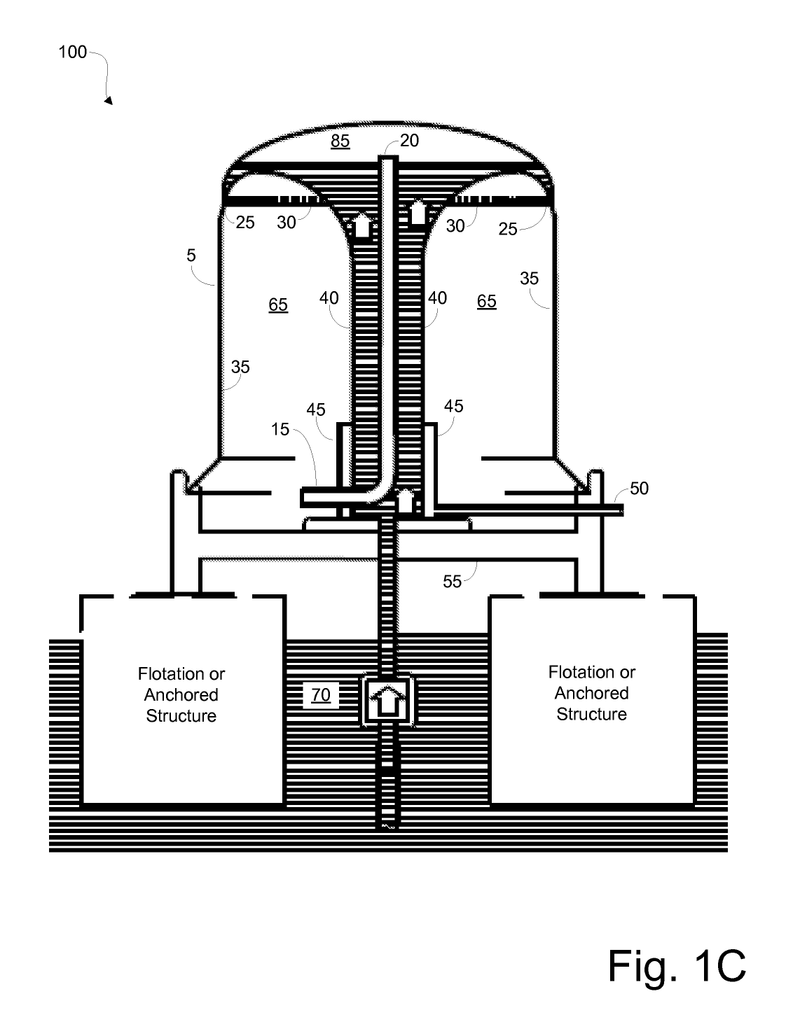

FIG. 1A is a cutaway perspective view of an exemplary application of a solar water still 100. In the illustrative application, the solar water still 100 is mounted above a raw, non-potable water source 70 such as a lake or pond. Solar radiation is depicted as a thermal energy source for heating the outer housing 5 and its inner evaporation surface 35, although it is envisioned that some embodiments may leverage other power sources to heat the evaporation surface 35 such as, but not limited to, electric heat tracing, space heaters, electric elements, open flame, etc. Some energy sources may be driven by stand alone power sources such as the exemplary photovoltaic panel 75 depicted in FIG. 1A. Notably, the photovoltaic panel 75, which is included for illustrative purposes only and will not be interpreted to limit the type of power source that may be included in any given embodiment of a solar power still, may also be used to drive the water intake pump 60 either directly or via charging of a capacitor, battery or other electric storage device (not shown) configured to drive the pump and/or heating components.

It will be understood that a solar water still may be modular such that it can couple to, and work with, additional components external to, or internal to, the solar water still. For example, it is envisioned that some solar water stills may include UV modules and/or chemical dispensing modules for killing pathogenic microorganisms, bacteria, or the like. Moreover, it is envisioned that some solar water still embodiments may include additional filtration modules for further purifying collected condensate.

FIG. 1B is a cross-sectional view of the illustrative embodiment of a solar water still 100 featured in FIG. 1A. It can be seen in FIG. 1B that the solar water still 100 includes an outer housing 5 that defines a lower interior space 65 between the interior wall 35 of the outer housing 5 and the exterior wall 40 of a central water intake tube or column 10. A pumping mechanism 60 is configured to supply water from a source 70 into the interior of the central column 10. The central column 10 is depicted as having a substantially consistent diameter, except at its upper end where it flares outward toward the interior surface of the outer housing 5. An upper interior space 85 is thus defined above the flare portion 80 of the column 10 and beneath an upper portion of the outer housing 5. Contained within the central column 10 is an overflow pipe 20 configured to control the water level in the upper interior space 85.

Notably, at the point of contact between the outermost edges defined by the flared or fluted aspect at the top end of the central column 10, a series of distribution slits 30 are arranged within the solar water still 100 to define a distribution contact area 25. The distribution slits 30 follow a path that is juxtaposed to, and concentric with, a plane defined by the interior wall 35 of the outer housing component 5. Thus raw water contained within the upper interior space 85 may enter the lower interior space 65 via the distribution slits 30. At the base of the central water intake column 10, a distillate or condensate collection container 45 is configured around the column 10 to collect condensate and discharge it via a discharge mechanism 50.

As is understood in the art, a solar water still 100 may be supported by a support structure 55. For use in applications where fluctuating water source 70 levels must be accommodated, the support structure 55 may include flotation mechanisms such as those depicted in the following FIG. 1C illustration. However, it will be understood that not all embodiments require or include flotation aspects and, as such, the inclusion or exclusion of flotation features will not limit the scope of a solar water still. It is envisioned that some embodiments may be configured for rigid mounting to more permanent structures such as, but not limited to, piling supported docks or walkways.

FIG. 1C is a cross-sectional view of the illustrative embodiment of a solar water still 100 featured in FIG. 1A, depicted with raw water received into the inner column component 10 and upper interior space 85. As indicated by the arrows, the water 70 is pumped up the central intake column 10 until its level clears the parabolic or fluted structure 80 at the top of the intake column 10. Notably, although the exemplary embodiment featured in the drawings and described herein includes a fluted shape at the top of the water intake column 10, one of ordinary skill in the art will recognize that a solar water still is not limited to include a fluted or parabolic feature at the top of the water intake column 10 in order to function as described herein. Consequently, it is envisioned that other geometric arrangements at the top of a water intake column 10 may be included within certain embodiments of a solar water still.

Returning to the FIG. 1C illustration, one of ordinary skill in the art will understand that the overflow pipe 20 controls the level of the water 70 in the upper interior space 85 by channeling any overflow out the discharge 15 port into the environmental surroundings. The water 70 is allowed to exit the upper interior space 85 through distribution slits 30 located at the distribution contact area 25 with the interior wall surface 35 of the outer housing 5.

As described above, the water 70 is sheeted down the interior wall surface 35, i.e. the evaporation surface 35, via the distribution slits 30. The evaporation surface 35 may have been heated by exposure to the sun or other heat source to a temperature capable of causing portions of the water 70 sheeted upon its surface to evaporate into the lower interior space 65. The water vapor contained in the lower interior space 65 may be condensed back into a liquid state via contact with the cool outer surface of the inner intake tube 10, i.e. the condensation surface 40. Notably, it is envisioned that condensation may occur anywhere along the outer surface of the inner intake column 10 including along the underside of the fluted structure at the top of the intake column 10. Advantageously in certain embodiments, by using a curved structure such as the fluted structure described above and depicted in the figures, a large condensation surface 40 may be provided and surface tension phenomena leveraged to direct condensate toward the distillate collection container 45.

Even so, while the geometric structure of the various components within a solar water still embodiment, including the fluted shape of the upper portions of the inner intake column 10 depicted in the figures, may be novel in and of themselves, the particular geometric aspects of any given embodiment will not limit the scope of a solar water still. That is, it is envisioned that the specific geometric arrangements of the various components will vary according to the embodiments. Moreover, it is envisioned that the structure described herein and depicted in the drawings may be scalable in some embodiments. For example, some embodiments may include a water intake column comprised of multiple tubes, much like the arrangement of a shell and tube heat exchanger, to increase the area available for condensation without having to unnecessarily increase the overall size of the solar water still. Similarly, it is envisioned that some embodiments may include a housing component 5 that defines an undulating surface in order to increase the opportunity for evaporation.

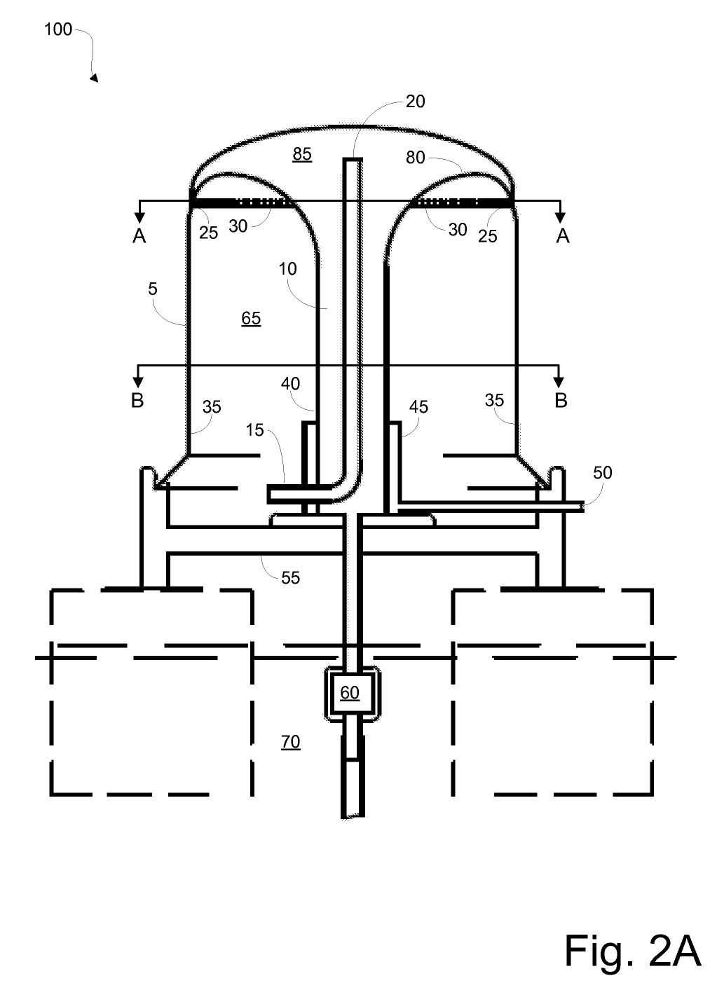

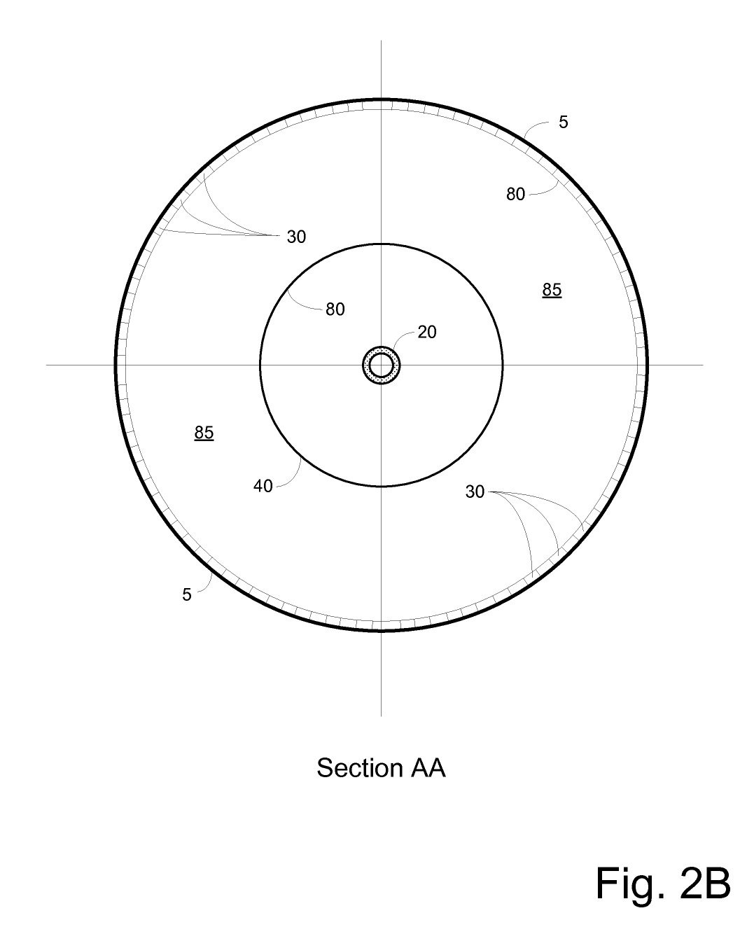

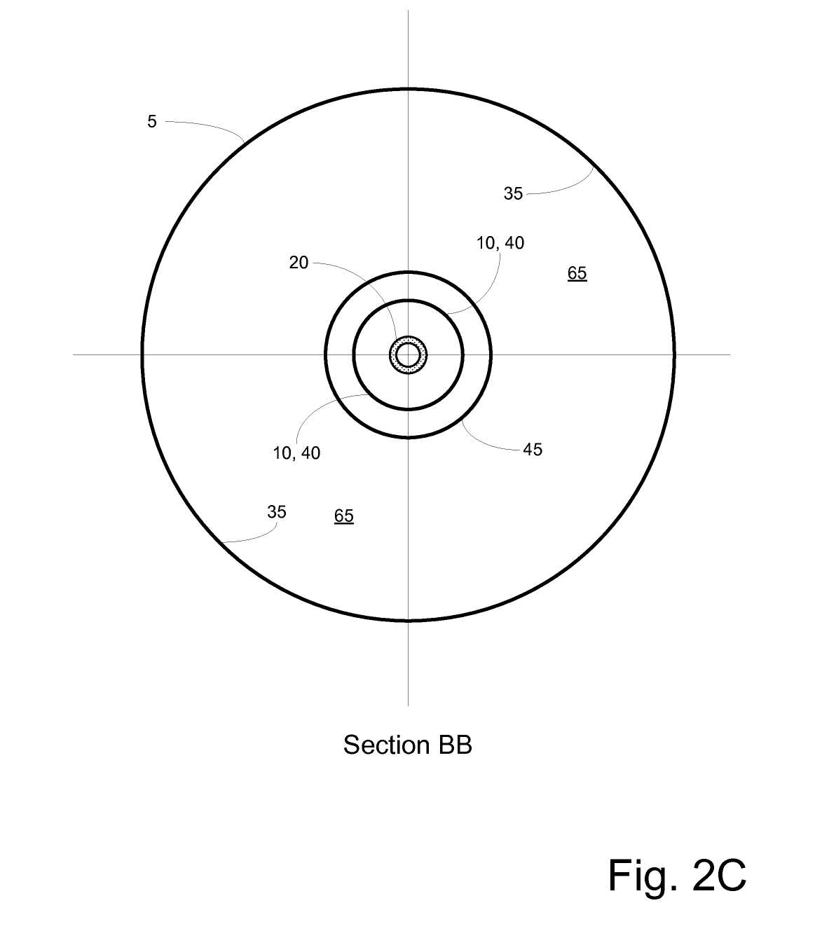

FIG. 2A is the cross-sectional view of the exemplary solar water still 100 depicted in FIG. 1B, shown with sectional lines AA and BB. FIGS. 2B and 2C are top plan views of the FIG. 1 embodiment depicted along the sectional lines AA and BB of FIG. 2A, respectively. Referring to FIG. 2B, the concentric relationship of the distribution slots 30 arrangement with the outer housing component 5/evaporation surface 35 can be seen. Notably, as described above, solar water stills are not limited in scope to such an extent that the distribution slots 30 must be arranged concentrically with the outer housing component or, indeed, that the outer housing component even define a circular cross-section. For this reason, one of ordinary skill in the art will understand that the particular embodiment(s) illustrated in the drawings and described in the specification are not meant to limit the scope of a solar water still to the particular geometric relationships shown.

Returning to the AA section illustrated in FIG. 2B, raw water received into the upper interior space 85 may enter the distribution slits 30 at the point at which the surface 80 communicates with the distribution slits 30, i.e. at the distribution contact area 25. Notably, by exiting the upper interior space 85 through the peripherally positioned distribution slits 30, the water may enter the lower interior space and run down the inner wall 35 of the outer housing component 5.

Referring to FIG. 2C, the positioning of the exemplary arrangement of the central intake column 10 and its outer condensation surface 40 relative to the condensate collection container 45 and evaporation surface 35 can be seen. Briefly referring back to the AA section illustrated in FIG. 2B, the raw water is allowed to enter the lower interior space 65 via the distribution slits 30. As the water passes through the distribution slits 30, it may come into contact with the interior surface 35 of the outer housing 5 and proceed to run down the surface 35. Because the surface is warm relative to the temperature of the water, a portion of the water may evaporate into the lower interior space 65 and then condense on the cool exterior surface 40 of the interior intake column 10. The condensate may then proceed to run down the exterior surface 40 where it is collected via the condensate collection container 45.

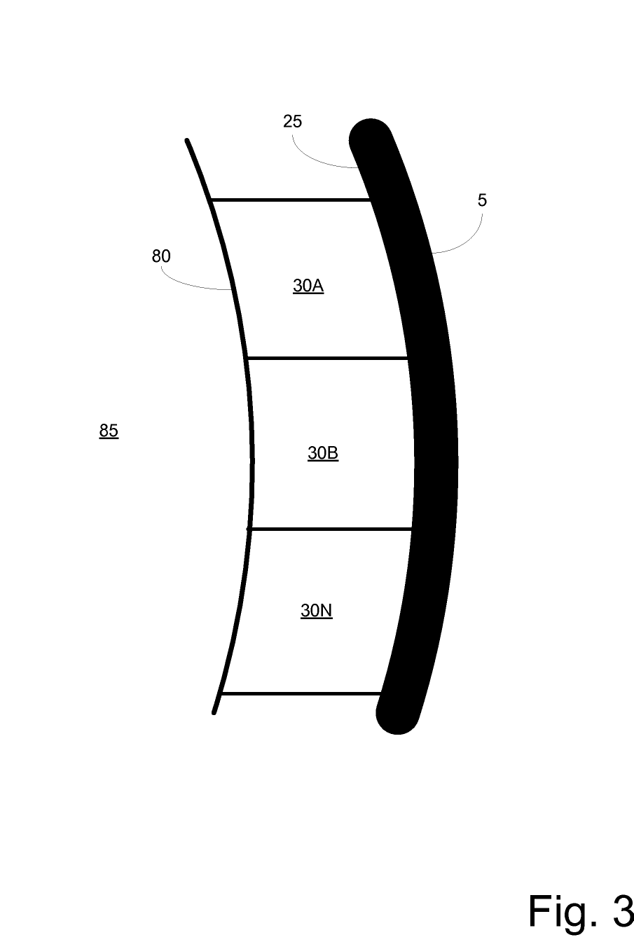

FIG. 3 is a detailed view of the distribution slots 30 of an exemplary embodiment of a solar water still 100. In the FIG. 3 illustration, the distribution edge 25 (becomes interior surface 35 of the outer housing 5) which defines the transition point at which the water 70 is distributed from the upper interior space 85 to the evaporation surface 35 via the distribution slots/slits 30 can be seen. The water, after having entered the upper interior space 85 via the water intake column 10, is allowed to flow over the upper surface 80 that flares outward at the top of the water intake column 10 and toward the distribution slots 30. The water may then exit the upper interior space 85 by passing through the distribution slots 30 into the lower interior space 65. Once the water passes through the distribution slots 30 into the lower interior space 65, a portion of the water may run down the interior surface 35 (i.e., the evaporation surface 35) as described above.

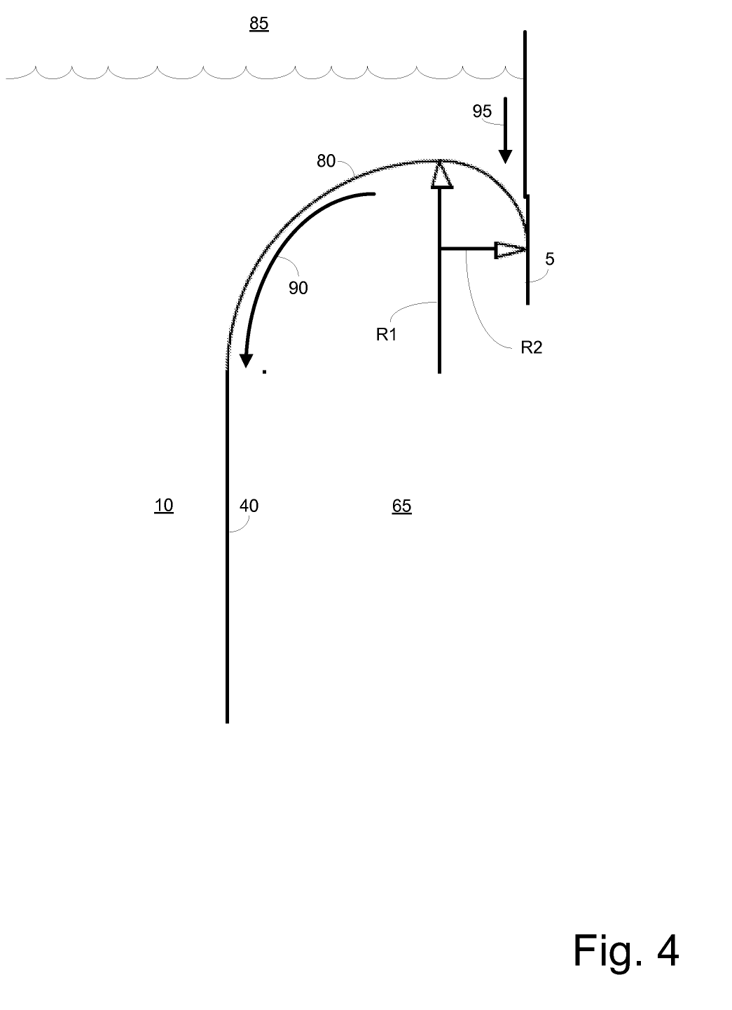

FIG. 4 is an illustration of a geometric relationship of an inner column 10 and outer housing 5 in an exemplary solar water still 100. Again, embodiments of a solar water still are not limited to the exemplary geometric relationship provided in the FIG. 4 illustration. As such, one of ordinary skill in the art will recognize that the geometric relationship illustrated in FIG. 4 is offered for exemplary purposes only—variations of the geometric shapes, configurations and relationships will occur to those of ordinary skill in the art and will not constitute a departure from the scope of the disclosure.

Referring to FIG. 4, the radius R2 may be on the order of half the radius R1. In such an arrangement, one of ordinary skill in the art will recognize the advantage that the larger radius R1 provides for a substantially increased condensation surface from which condensed vapor within the lower interior space 65 may travel down the exterior of the water intake column 10 along surface 40, as depicted by directional arrow 90. Similarly, the relatively smaller radius R2 provides efficient head pressure (as depicted by vector 95) for raw water in the upper interior space 85 to pass through the distribution slits 30.

Various aspects, features and characteristics of a solar water still have been described using detailed descriptions of embodiments thereof that are provided by way of example and are not intended to limit the scope of the disclosure. The described embodiments comprise different features, not all of which are required in all embodiments of a solar water still. Some embodiments of a solar water still utilize only some of the features or possible combinations of the features. Variations of embodiments of a solar water still that are described and embodiments of a solar water still comprising different combinations of features noted in the described embodiments will occur to persons of the art.

It will be appreciated by persons skilled in the art that systems, devices and methods for the provision of solar water still is not limited by what has been particularly shown and described herein above.

What is claimed is:

1. A system for generating and collecting potable water from a non-potable water source, the system comprising:
an upper interior space and a lower interior space;
an inner column component for directing water from a water source into the upper interior space, wherein the inner column component passes through the lower interior space; and
one or more distribution slits for providing passage of the water from the upper interior space into the lower interior space;
wherein when the water passes into the lower interior space a portion of the water is allowed to wet an interior surface of an outer housing component that has been warmed relative to the temperature of the water by virtue of exposure to a thermal energy source;
wherein a portion of the water that is allowed to wet the interior surface of the outer housing component evaporates into the lower interior space; and
wherein a portion of the water that evaporates into the lower interior space condenses on an exterior surface of the inner column component.

2. The system of claim 1, further comprising a collection component positioned at a lower end of the inner column component configured to receive condensed water that runs down the exterior surface of the inner column component.

3. The system of claim 1, further comprising a photovoltaic panel for providing an energy source.

4. The system of claim 3, further comprising a pump for pumping the water through the inner column component and into the upper interior space, wherein the energy source for the pump is the photovoltaic panel.

5. The system of claim 3, further comprising a heating element for heating the outer housing component, wherein the energy source for the heating element is the photovoltaic panel.

6. The system of claim 1, wherein the thermal energy source is the sun.

7. The system of claim 1, wherein a portion of the water that is allowed to wet the interior surface of the outer housing component runs down the interior surface and exits the solar water still into the ambient environment.

8. The system of claim 1, wherein the inner column component is comprised of a plurality of tubes.

9. The system of claim 1, further comprising an overflow pipe that is configured to limit the water level in the upper interior space.

10. The system of claim 1, wherein the inner column component flares at its upper end to define a curved surface that forms the upper interior space in conjunction with an interior surface of the outer housing component.

11. The system of claim 1, wherein the outer housing component comprises a bell-shape.

12. The system of claim 1, further comprising a chemical dispensary for dispensing water treatment chemicals into the water or condensate.

13. The system of claim 1, further comprising an ultraviolet (“UV”) purification module for treating the water or condensate via ultraviolet exposure.
